(19) United States
(12) Patent Application Publication
(10) Pub. No.: US 2003/0135472 A1
(43) Pub. Date: Jul. 17, 2003

(54) Monetary funds with attributes

(76) Inventor: Daniel David Lang, Las Vegas, NV (US)

Correspondence Address: Daniel Lang, 101 South Rainbow Blvd. #28-39, Las Vegas, NV, 89145, US

(21) Appl. No.: 10/046,351

(22) Filed: Jan. 14, 2002

(51) Int. Cl. G06F 17/60

(52) U.S. Cl. 705/75; 705/16

(57) ABSTRACT

A method that utilizes a physical means to verify that funds were obtained and/or used within a geographical area. It allows for age and identity verification.

### CROSS REFERENCE TO RELATED APPLICATIONS

Not applicable

### BACKGROUND OF INVENTION

Many financial transactions and products have legal requirements. Some of which are: the age of the parties involved and or the geographical location of the transaction. For example gambling or gaming is allowed by geographical region and has age requirements. This method provides a means to obtain and or verify the necessary attributes as well as other beneficial features for financial transactions.

### SUMMARY OF INVENTION

A method that utilizes a physical means to verify that funds were obtained and/or used within a geographical area. It allows for age and identity verification.

### DETAILED DESCRIPTION

It is desirable and sometimes required to have additional attributes verified with funds. Gambling, often referred to as gaming in the industry, is allowed in geographical areas and has age requirements. Some content on public accessable networks also have age and geographical requirements. “Card-not-present” telephone and Internet transactions carry risks and higher processing fees. The risk of “card-not-present” transactions to consumers and retailers, service providers is that someone else can get access to a card number and expiration date (either by hacking a website or searching the trash for a receipt or credit card statement) and use them to make fraudulent purchases by telephone or mail order or on the Internet. Many consumers remain especially reluctant to share their credit card information over the Internet. This may be why an estimated two-thirds of Internet shopping carts are abandoned without a checkout. Recent, highly publicized hacking of major websites has helped to substantiate these concerns. The hacking of a major site can compromise the financial and personal information of hundreds of thousands of consumers. In the United States, financial institutions bear the liabilty for fraudulent transactions made with credit and ATM/debit cards at the Point of Sale (POS), if a retailer has complied with required procedures. In contrast, retailers bear the liability for Internet and both mail-order/telephone transactions. Which are inherently riskier than “card-present” transactions. Thus, retailers risk absorbing the transaction amount, which is called a “chargeback” for purchases that a consumer denies making, everytime they accept a “card-not-present” Internet or mail/telephone purchase. Addition to the chargebacks for purchases made with stolen card numbers or cards, “card-not-present” retailers face additional risk that POS (Point of Sale) retailers do not. Customers place orders with their own valid card numbers and then claim that they neither ordered or received the product or service. This results in additional chargeback losses. Internet fraud is estimated to be in the billions of dollars.

The present invention includes the recognition of certain problems including problems generally as discussed above. According to one embodiment, a self-help or employee operated Point of Sale (POS) system can accept instruments of value such as smart-cards, credit cards, ATM/debit cards, gift cards, prepaid cards, currency/coins and vouchers. The Point of Sale method provides a means of verifying, validating geographical location, age and identity of a consumer, purchaser or source of funds, as well as the availability of funds for the purchase. Upon acceptance of the instrument of value, a new instrument of value, which can be pre-existing, pre-printed or dynamically produced is issued, which can be a receipt, card, voucher and/or electronic means device such as a card or smart-card. This instrument of value contains a means of describing funds obtained. This can be a coded number with or without additional information about said funds such as amounts, time and place of obtainment. For added security a PIN number can be associated with the purchase of an instrument of value. The funds obtained by the Point of Sale method are verified and validated to provide any or all following desired or necessary features or qualities: geographical location, amount of funds, age and identity information.

In one embodiment, a receipt includes preferably a printed coded number. The number can be presented for use in financial transactions. This provides many advantages. In the case of public networks such as the Internet, this allows the many advantages including but not limited to the following: protection of the private information of the purchaser or consumer, (as it is not needed or even available to the possibly hackable network), the geographical and age attributes are used to allow transactions when applicable. Allows the use of additional types of funds such as currency, coins, travel checks and other physical instruments of value in a electronic, networked, wired transactions environment. Losses and issues due to “card-not-present” transactions are eliminated. Anonymity of the purchasers can be maintained as no private information is needed. Physical security and monitoring can be used at the Point of Sale for enhanced security. Refunds and in a gambling, gaming environment winnings can be verified and validated at the Point of Sale system. This provides more controls and checks of attributes such as geographical location and age verification, which is important to many financial transactions, one of which is a gaming, gambling environment.

### BRIEF DESCRIPTION OF THE DRAWING

FIG. 1 depicts the appearance of a receipt of a type which may be used in accordance with an embodiment of the present invention.

### DETAILED DESCRIPTION OF THE PREFERRED EMBODIMENT

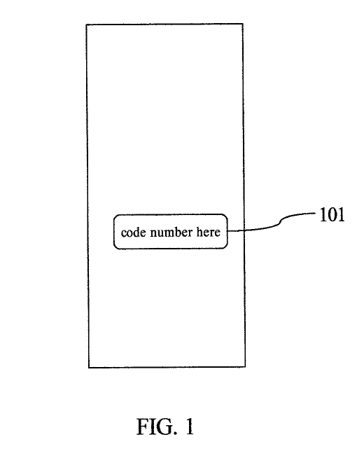

FIG. 1 shows the appearance of a receipt of a type which may be used in connection with embodiments of the present invention. The present invention can be used with a number of types of paper or non-paper (such as electronic) instruments. An electronic instrument may include a computer and/or network system that can associate validated funds with a code number, account number and/or PIN number. In the example of FIG. 1, the instrument is a paper instrument with a coded number printed thereon. This may be pre-printed (before a transaction occurs) or the entire instrument may be printed after an instrument of value is accepted by the Point of Sale system. The funds are accepted and various attributes can be verified and recorded. Some attributes may be implied such as the geographical location due to knowledge of the Point of Sale's location and minimum age due to physical checking. If desired a PIN number is associated with the funds. In one embodiment, the coded number is presented through normal retail transactions or facilities. The coded number is validated and the retailer or service provider is assured that the funds have been verified and meet their requirements and are valid without the need of personal or private information.

I claim:

1. A method of providing funds with attributes that are validated comprising:
a Point of Sale method that accepts instruments of value and attributes such as geographical location and age are validated and verified.
a means of storing funds in an electronic accessable form
an instrument that contains information to facilitate access to said funds.
